(19) United States
(12) Patent Application Publication
(10) Pub. No.: US 2020/0070696 A1
(43) Pub. Date: Mar. 5, 2020

(54) Seat Ventilation Device for a Seat System, in Particular of a Motor Vehicle

(71) Applicant: Daimler AG, Stuttgart (DE)

(72) Inventor: Sven FRIDERICH, Boeblingen (DE)

(73) Assignee: Daimler AG, Stuttgart (DE)

(21) Appl. No.: 16/614,653

(22) PCT Filed: May 8, 2018
(86) PCT No.: PCT/EP2018/061750

§ 371 Date: Nov. 18, 2019

(30) Foreign Application Priority Data
May 18, 2017 (DE) 10 2017 004 761.8

(51) Int. Cl. B60N 2/56; B60N 2/64; B60H 1/00; F04D 1/04

(52) U.S. Cl. CPC B60N 2/5657; F04D 1/04; B60H 1/00285; B60N 2/646

(57) ABSTRACT

A seat ventilation device for a seat system, in particular of a motor vehicle, includes a plurality of radial fans for conducting air and at least one cushion which has a foam support and a ventilation layer which is arranged over or in front of the foam support and through which air conducted by the radial fans can flow. The radial fans are at least partly received in the foam support and are arranged below or behind the ventilation layer.

### BACKGROUND AND SUMMARY OF THE INVENTION

The invention relates to a seat ventilation device for a seat system, in particular of a motor vehicle.

A seat ventilation device of this kind for a seat system, in particular of a motor vehicle, is already disclosed in DE 10 2005 003 849 B3, for example. The seat ventilation device has a plurality of radial fans for conveying air. The seat ventilation device also comprises at least one cushion, which can be supported, for example, on a seat frame and is used to cushion the seat system formed for example as a single seat or as a bench seat. In this case, the cushion comprises a foam pad and a ventilation layer which is arranged above the foam pad, through which layer the air conveyed by the radial fans can flow. The foam pad is usually formed of a foam material, the ventilation layer usually being formed by a knitted spacer fabric.

The problem addressed by the present invention is that of further developing a seat ventilation device of the aforementioned type such that a particularly high level of seating comfort can be achieved in a particularly cost-effective manner.

In order to develop a seat ventilation device such that a particularly high level of seating comfort can be achieved in a particularly cost-effective manner, according to the invention, the radial fans are at least partially, in particular at least predominantly or completely, received in the foam pad, i.e., embedded in the foam pad, for example, and are therefore arranged so as to be recessed in the foam pad, for example, the radial fans being arranged below or behind the ventilation layer. This means that the radial fans are arranged on a lower face of the ventilation layer that faces the foam pad, and are therefore not arranged next to the ventilation layer, for example.

The invention is based in particular on the finding that radial fans are distinguished by a high pressure buildup and therefore by the fact that they can even convey air through very dense seat assemblies, the term “convey” including both a suctioning and a blowing system. This is particularly advantageous in a occupied state of the seat system. An occupied state of this kind means that an occupant, also referred to as a seat occupant, is seated on the seat system and, in particular, on a seat surface of the seat system and therefore on the cushion. In an occupied state of this kind, axial fan systems quickly reach the limits thereof with regard to the volume of air the systems convey. Usually, however, radial fans are louder than axial fans in terms of the background noise thereof, such that—if no corresponding countermeasures are taken—radial fans can cause a noise which is acoustically perceptible to the occupant in the interior of a motor vehicle and is perceived as unpleasant by the occupant.

If radial fans are mounted below a seat cushion or behind the backrest, for example, in particular due to the dimensions thereof, and are therefore, for example, mounted completely below the cushioning, airborne noise can be emitted, unhindered, by the radial fans, leading to unpleasant noises. Furthermore, the space required for such an arrangement of radial fans is considerable, since this arrangement of radial fans below or behind the cushioning, and therefore in particular below the foam pad, is at the expense of foot room. This arrangement also causes additional costs, since each radial fan must be additionally protected. In addition, rotating parts, such as those used in fans, are naturally unbalanced and have to be decoupled in a complex manner, so as not to pass the structure-borne noise to the occupants.

However, since, according to the invention, the radial fans are at least partially, in particular at least predominantly or completely, embedded in the foam pad, and are arranged below or behind the ventilation layer and therefore, for example, on the lower face of the ventilation layer that faces away from a seat surface or the backrest surface, a noise reduction can be achieved in a particularly simple and cost-effective manner, such that no airborne sound is transmitted unhindered from the radial fans to the seat occupants. In other words, the generation of unpleasant noises can be avoided by embedding the radial fan in the foam pad, according to the invention. In addition, the radial fans are at least partially, in particular at least predominantly or completely, arranged in and therefore not below the cushion foam pad or behind the backrest foam pads, such that additional components for protecting the radial fan can also be avoided. As a result, the number of parts, the installation space requirement and the cost of the seat ventilation device can be kept particularly low.

Furthermore, by arranging the radial fans below the ventilation layer, the air conveyed by the radial fans can be conveyed and guided in a particularly advantageous manner, such that, for example, the air flowing out of the radial fans and flowing away from the radial fans particularly advantageously, and in particular at least substantially, flows through the ventilation layer in a uniform or homogeneous manner and can distribute particularly advantageously. A particularly high level of comfort can be achieved as a result. In other words, an outlet shape, in particular of the radial fans, that is optimal in terms of flow can be achieved since, for example, sufficient space is available.

The arrangement of the radial fans below the ventilation layer is in particular to be understood as meaning that the ventilation layer is arranged between the radial fans and the seat surface of the seat ventilation device that is, for example, formed by a seat cover of the seat ventilation device, or is arranged between the radial fans and the seat system as a whole. In this case, for example, the cushion which is also referred to as cushioning is covered by the seat cover.

The foam pad is formed, for example, from a foam material, which, considered in itself, may be impermeable to air. In this case, for example, the foam material or the foam pad has at least one feed channel per radial fan, via which the relevant radial fan can suction in or blow out air. The air can therefore flow through the relevant feed channel to the relevant radial fan. The foam pad or the foam material also, for example, has at least one discharge channel per radial fan, through which channel the air conveyed by the relevant radial fan and flowing from the relevant radial fan can flow.

The ventilation layer is formed, for example, by at least one knitted spacer fabric. For example, the ventilation layer and the foam pad are formed from mutually different materials. The arrangement of the ventilation layer above the foam pad is understood in particular to mean that, as described above, the ventilation layer is arranged between the seat cover or the seat surface formed by the seat cover, and the foam pad.

A further advantage of the seat ventilation device according to the invention lies in what is referred to as the multi-part design of the seat ventilation. This is to be understood as meaning that it is not exactly one radial fan that is used, for example, the seat ventilation device according to the invention instead comprises a plurality of radial fans. As a result, a sufficiently large air volume flow or air mass flow can be achieved. At the same time, the radial fans can be designed to be sufficiently small in terms of their external dimensions, in order to be able to advantageously integrate the fans into the foam pad. In addition, due to the higher power density of radial fans in comparison with axial fans, fewer radial fans than axial fans are required. This means that, for example, a predeterminable power, with regard to conveying a predeterminable air mass flow or air volume flow, can be achieved using fewer radial fans than axial fans, such that the costs can be kept particularly low. According to the invention, a plurality of small radial fans are therefore inserted into the foam pad, which is also referred to as a cushion or backrest, for example, as a result of which the radial fans can easily be installed so as to be vibration-decoupled.

These advantages result from the fact that radial fans, per se, are less susceptible to vibrations because they run at a far lower rotational speed than the axial fans. The rotational speed is squared when entered into the vibration. This eliminates the need for the defined complex vibration decoupling using rubber elements that is required by axial fans. It is also very advantageous for avoiding the transmission of structure-borne (vibration) and airborne noise (noise), to integrate the fans into the foam pad.

In order to achieve a particularly high level of comfort in a particularly cost-effective manner, in an advantageous embodiment of the invention, the radial fans are completely received in the foam pad with respect to the axial extension of the fans. As a result, the radial fans, for example, both in terms of their radial direction and in terms of their axial direction are particularly advantageously installed so as to be vibration-decoupled, such that the generation of unwanted vibrations and noises can be easily avoided.

A further embodiment is characterized in that the radial fans are each completely covered by the ventilation layer in the direction of the seat surface of the seat ventilation device. In other words, the radial fans are covered by a broad face of the ventilation layer, and not by an end or narrow face of the ventilation layer, in the direction of the seat surface. As a result, for example, the air which is conveyed by the radial fans, flows out of the radial fans and, for example, flows away from the radial fans, cannot or cannot only flow or be blown into the ventilation layer via a narrow or end face, but instead via the broad face, and/or the air which is conveyed by the radial fans is not or is not only suctioned away from the ventilation layer via the end or narrow face, but instead via the broad face of the ventilation layer, as a result of which an at least substantially homogeneous air distribution and, consequently, a particularly high level of seating comfort can be ensured.

In a further embodiment of the invention, each radial fan has at least one outlet opening through which the air can flow, via which the conveyed air can be conducted out of the relevant radial fan. Furthermore, the respective radial fan has, for example, at least one inlet opening, via which the air conveyed by the radial fan can be conducted into the relevant radial fan. The radial fan therefore suctions in air which can flow into the relevant radial fan via the inlet opening. The air which can flow out of the radial fan via the outlet opening is conveyed as a result.

In this case it has been found to be particularly advantageous for the respective outlet openings to the seat surface and backrest surface of the seat ventilation device to each be completely covered by the ventilation layer. In particular, each radial fan is operated or is operable such that, during an operation of the relevant radial fan, the air conveyed by the relevant radial fan flows in a flow direction through the outlet opening and therefore flows away from the radial fan. In this case, this flow direction preferably faces the seat surface or backrest surface, or the flow direction extends toward the seat surface, as a result of which, for example, the air conveyed by the relevant radial fan is blown into the ventilation layer. Alternatively or additionally, the radial fan is operable or arranged such that the flow direction points away from the seat surface, for example, such that the air conveyed by the relevant radial fan is then suctioned away from the ventilation layer, for example. Due to the ventilation layer completely covering the outlet openings, the conveyed air can be distributed evenly such that a particularly high level of comfort can be easily achieved.

In a particularly advantageous embodiment of the invention, each radial fan has at least one fan wheel for conveying the air. During an operation of each radial fan, the air conveyed by the relevant radial fan flows into the fan wheel, for example, at least substantially in the axial direction, is deflected by the radial fan, in particular by the fan wheel, and flows away from the fan wheel in the radial direction of the radial fan or of the fan wheel. In this case, for example, a deflection, in particular a first deflection, of the air by at least substantially 90°, for example, is effected.

In this case it has been found to be particularly advantageous for each radial fan to have at least one deflection channel through which the air can flow, and which has the relevant outlet opening for the conveyed air, by means of which channel air which is conveyed by the fan wheel, thereby flows to the fan wheel in the axial direction of the fan wheel and flows away from the fan wheel in the radial direction of the fan wheel, can be, or is deflected, such that the air flows through the outlet opening at least substantially in the axial direction of the fan wheel and as a result flows out of the respective radial fan or the deflection channel at least substantially in the axial direction. A second deflection of the conveyed air is therefore effected, for example, by means of the deflection channel, which air is deflected, for example, by at least substantially 90° in the course of the second deflection. The air flowing away from the fan wheel in the radial direction therefore does not flow out of the radial fan in the radial direction, for example, but instead in the axial direction. A particularly space-saving arrangement of each radial fan can be achieved as a result, such that in particular an extension of the seat ventilation device which extends at least substantially perpendicularly to the seat surface can be kept particularly low. In addition, the air can be particularly evenly distributed in the ventilation layer as a result, such that a particularly high level of seating comfort can be achieved.

In a further embodiment of the invention, each radial fan has a first extension extending in the axial direction of the relevant radial fan, and the ventilation layer has a second extension extending in the axial direction of the relevant radial fan, which extension is smaller than the first extension. In other words, the ventilation layer, in particular along a direction which extends at least substantially perpendicular to the seat surface, is thinner than the radial fan, such that the space requirement of the seat ventilation device can be kept particularly low.

In order to achieve a particularly high level of comfort in a particularly cost-effective manner, at least or exactly three radial fans are provided in a further embodiment of the invention.

A further embodiment is characterized in that two of the radial fans are arranged below the ischial tuberosities, and at least one of the radial fans is arranged below a thigh of an occupant seated on the seat system. In other words, with respect to a state in which an occupant is sitting on the seat ventilation device, and more particularly on the seat surface, i.e., with respect to the aforementioned occupied state, two of the radial fans are arranged below the ischial tuberosities and one of the radial fans is arranged below the thigh of the occupant.

Finally, it has proven to be particularly advantageous for the seat cover, by means of which the cushion is covered, for example, to have a plurality of passage openings, in particular outlet openings, for the air conveyed by the radial fans. The air can therefore flow through the passage openings or outlet openings and therefore the seat cover, such that, for example, the air conveyed by the radial fans can escape out of the seat ventilation device via the passage openings, in particular into the interior of the motor vehicle. In contrast to conventional seat ventilation devices, in which passage openings of this kind are accommodated in the cushion itself, according to the invention the passage openings are provided in the seat cover. Thus, for example, the air can flow out over the entire seat surface, and not at discrete or specific air outlet points on what is known as a B side, as a result of which a particularly high level of seating comfort can be achieved.

The seat ventilation device according to the invention is a ventilation concept which can be used for seat systems such as single seats or seat benches, for example. The ventilation concept for seats of the first row of seats and for one or more rear seats has proven to be particularly advantageous for achieving a particularly high level of seating comfort in a space-saving manner.

Further advantages, features and details of the invention can be found in the following description of a preferred embodiment and with reference to the drawings. The features and feature combinations mentioned above in the description, as well as the features and feature combinations mentioned below in the description of the drawings and/or in the drawings alone can be used not only in each indicated combination, but also in other combinations or in isolation, without departing from the scope of the invention.

### BRIEF DESCRIPTION OF THE DRAWINGS

FIG. 1 shows a schematic and sectional side view of a seat ventilation device for a seat system, in particular of a motor vehicle, comprising a plurality of radial fans, which are at least partially received in a foam pad of a cushion of the seat ventilation device and are thereby arranged below a ventilation layer of the cushion;

FIG. 2 is a schematic and perspective side view of the radial fan; and

FIG. 3 is a schematic and sectional plan view of the seat ventilation device.

### DETAILED DESCRIPTION OF THE DRAWINGS

In the drawings, identical or functionally identical elements are provided with the same reference signs.

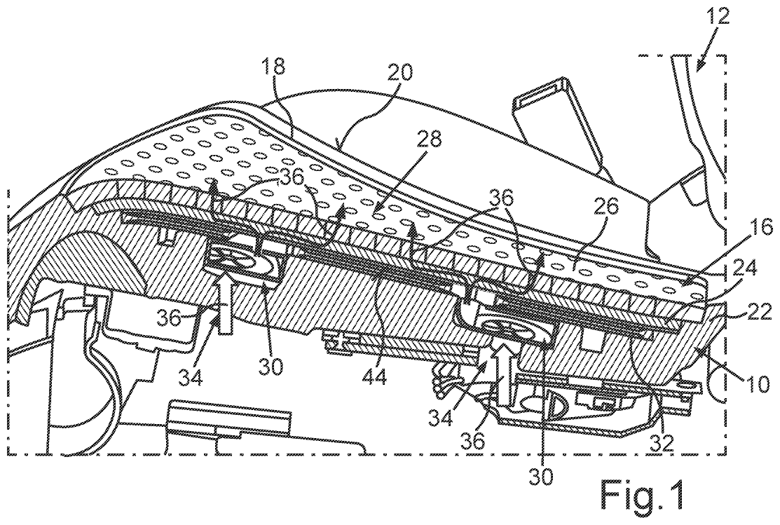

FIG. 1 shows a schematic and sectional side view of a seat ventilation device for a seat system 12, in particular of a motor vehicle such as a passenger car, which device as a whole is denoted by reference numeral 10. In the embodiment illustrated in FIG. 1, the seat system 12 is designed as a single seat, such that the seat system 12 provides exactly one seat for an occupant who is also referred to as a seat occupant. However, the previous and following embodiments can be easily transferred to a seat system designed as a bench seat, wherein the seat system provides a plurality of seats for the respective occupants. In particular, it is conceivable that the seat system 12 is designed as a rear seat system, and therefore is used in a rear area of the motor vehicle. The seat is therefore a rear seat, for example.

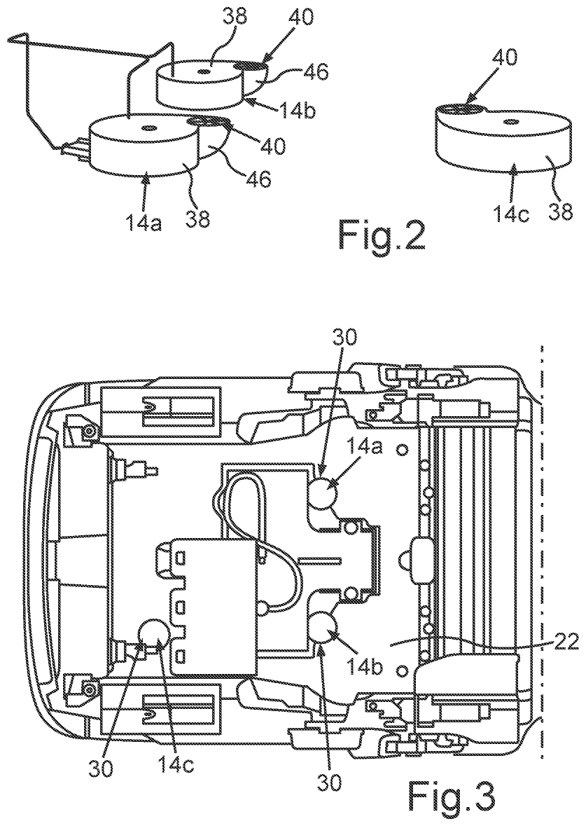

The seat ventilation device 10 comprises a plurality of radial fans 14a-c which can be seen particularly well in FIGS. 2 and 3, the exemplary embodiment illustrated in the drawings comprising exactly three radial fans 14a-c. Air can be conveyed by the relevant radial fan 14a-c, as is explained in more detail below.

The seat ventilation device 10 further comprises a cushion 16, which is also referred to as cushioning. In addition, the seat ventilation device 10 comprises a seat cover 18 which the cushion 16 is covered by. The seat cover 18 is also simply referred to as a cover, and forms a seat surface 20 on which the aforementioned occupant can sit. In a state in which the occupant sits on or in the seat system 12, the occupant sits on the seat surface 20 and therefore on the seat cover 18 and the cushion 16. In this case the seat occupant touches the seat surface 20. This state is also referred to as an occupied state.

The cushion 16 comprises a foam pad 22, which is formed for example from a foam material. The foam material itself is, for example, impermeable to air. In addition, the cushion 16 comprises a ventilation layer 24 which is arranged above at least a portion of the foam pad 22, and which is formed, for example, by a knitted spacer fabric, in particular made of rubber fibers. The air conveyed by the radial fans 14a-c can flow through the ventilation layer 24. The feature that the ventilation layer 24 is arranged above the foam pad 22 or above at least one portion of the foam pad 22 is to be understood in particular as meaning that the ventilation layer 24 is arranged between the seat surface 20 and the foam pad 22 or the portion of the foam pad 22.

In addition, the cushion 16 includes a foam layer 26 arranged on the ventilation layer 24, which foam layer is also referred to as a foam pad, for example, and is formed by a cut foam layer, for example. In this case, the foam pad 26 is arranged on a face of the ventilation layer 24 that faces away from the foam pad 22, in particular on the upper face 28, such that the ventilation layer 24 is arranged between the foam layer 26 and the foam pad 22 or the portion of the foam pad 22. For example, the foam pad 26 has a plurality of through-flow openings, through which the air conveyed by the radial fans 14a-c can flow.

In order to be able to achieve a particularly high level of comfort in a particularly cost-effective manner, the radial fans 14a-c are at least partially received in the foam pad 22 and in this case are arranged below the ventilation layer 24. It is particularly clear from FIG. 1 that the radial fans 14a-c are completely received in the foam pad 22 with respect to the axial extension of the fans. In other words, the radial fans 14a-c are received or installed in the foam pad 22 so as to be recessed. An in particular intrinsically rigid, grid is arranged above the respective radial fans 14a-c, for example, which grid is formed, for example, by the ventilation layer 24. Alternatively, it is conceivable that relevant grid is formed separately from the ventilation layer 24 and in this case is arranged between the ventilation layer 24 and the relevant radial fan 14a-c.

The foam pad 22 has, for example, one corresponding receptacle 30 per radial fan 14a-c, in which receptacle the relevant radial fan 14a-c is at least partially received. By means of the respective grid, it can be avoided, for example, that the ventilation layer 24 is pressed into the relevant receptacle 30, in particular in the occupied state of the seat system 12. In the embodiment illustrated in the dawings, the seat ventilation device 10 also includes a massage device 32, which is also referred to as a massage cushion. The occupant seated on the seat system 12 can be massaged by the massage device 32.

It is clear from FIG. 1 that the foam pad 22 has at least one feed channel 34 per radial fan 14a-c, through which channel the air conveyed by the means of the radial fan 14a-c can flow. Each radial fan 14a-c can therefore suction in air via the relevant feed channel 34, for example, such that the air suctioned in and conveyed by each radial fan 14a-c flows through the relevant feed channel 34 and therefore can flow via the relevant feed channel 34 to the relevant radial fan 14a-c. The suctioned air can flow through the relevant radial fan 14a-c and flow away from the relevant radial fan 14a-c, and as a result flow into the ventilation layer 24, for example. For this purpose, each feed channel 34 opens into the relevant receptacle 30, for example, which has at least one discharge opening, through which the conveyed air can flow. The conveyed air can therefore flow through the discharge opening and, via the discharge opening, can flow out of each radial fan 14a-c and into the relevant ventilation layer 24. In FIG. 1, the arrows 36 illustrate the air conveyed by the radial fans 14a-c or the flow thereof through the feed channels 34, the radial fans 14a-c, into and through the ventilation layer 24 and through the foam pad 26. By embedding the radial fans 14a-c into the foam pad 22, a particularly advantageous noise reduction and vibration decoupling of the radial fans 14a-c can be achieved such that unpleasant airborne and structure-borne noise caused by the radial fans 14a-c during the operation thereof can be avoided. The foam pad 22 is therefore used as a surrounding foam volume for damping vibration and airborne sound.

It is particularly clear from FIG. 2 that each radial fan 14a-c has a relevant housing 38 in which, for example, a relevant fan wheel for conveying the air is rotatably received. In this case, each radial fan 14a-c has an outlet opening 40 formed by the housing 38, for example, through which the conveyed air can flow. The conveyed air can be conducted out of each radial fan 14a-c via the relevant outlet opening 40. In this case, the radial fans 14a-c are arranged such that the respective outlet openings 40 are each completely covered by the ventilation layer 24 in the direction of the seat surface 20. The air flowing through each outlet opening 40 flows in a flow direction through the relevant outlet opening 40 and away from the relevant radial fan 14a-c. In the embodiment illustrated in the drawings, the flow direction points towards the seat surface 20, such that the conveyed air is blown into the ventilation layer 24. In this case it is particularly clear from FIG. 1 that the air is not blown into the ventilation layer 24 via an end face or narrow face 42 thereof, but the air is instead blown into the ventilation layer 24 via a broad face 44 which faces the radial fans 14a-c and in particular the outlet openings 40, and faces away from, for example, the seat surface 20. If the radial fans 14a-c are operated in such a way, for example, or if the radial fans 14a-c are arranged in such a way, for example, that the air is not blown into the ventilation layer 24, for example, but instead is suctioned away from the ventilation layer 24, then the air is not suctioned away via the narrow face 42, but instead via the broad face 44. As a result, a particularly uniform or homogeneous air distribution can be ensured such that a particularly high level of comfort can be achieved. In this case, the inlet opening is protected by a grid, which may be either separately or directly connected, for example over-molded. It is also conceivable that the knitted spacer fabric has a sufficient inherent rigidity due to suitable measures.

During each operation, the air conveyed by the relevant radial fan 14a-c flows into the fan wheel at least substantially in the axial direction of the fan wheel, and therefore of the relevant radial fan 14a-c, and is in particular deflected by means of the fan wheel or by means of the relevant radial fan 14a-c by at least substantially 90°, such that the air flows away from the radial fan at least substantially in the radial direction thereof. There is therefore a first deflection of the air, since the air first flows into the fan wheel in the axial direction and flows away in the radial direction. In this case, each radial fan 14a-c has at least one deflection channel 46 which is formed, for example, by the housing 38 and has the outlet opening 40, by means of which channel, for example, a second deflection of the air is effected after the first deflection. In the course of the second deflection, the air is deflected, for example, by at least substantially 90°, such that the air flows through the relevant outlet opening 40 at least substantially in the axial direction of the relevant radial fan 14a-c, and therefore flows away from the respective radial fan 14a-c. As a result, the radial fans 14a-c can be arranged in a particularly space-saving manner, such that in particular a thickness of the seat ventilation device 10 that extends at least substantially perpendicular to the seat surface 20 can be kept particularly low. A particularly high air mass flow or air volume flow can be achieved at the same time, such that a high level of comfort can be achieved. It is also clear from FIG. 1 that each radial fan 14a-c has a first extension extending in the axial direction of the relevant radial fan 14a-c, and the ventilation layer 24 has a second extension extending in the axial direction of the relevant radial fan 14a-c, which second extension is smaller than the first extension is.

It is particularly clear from FIG. 3 that the seat ventilation device 10 has exactly three radial fans 14a-c. In this case, the radial fans 14a and 14b are arranged, with respect to the occupied state of the seat system 12, below the ischial tuberosities of the occupant, while, with respect to the occupied state of the seat system 12, the radial fan 14c is arranged below a thigh of the occupant.

Furthermore, the seat cover 18 preferably has a plurality of passage openings for the air conveyed by the radial fans 14a-c. The passage openings of the seat cover 18 are formed, for example, by a perforation. Since the seat cover 18 has the passage openings, in the embodiment illustrated in the drawings they can function as air outlet openings, via which the air conveyed by the radial fans 14a-c can flow out of the seat ventilation device 10 and, for example, towards the occupant. The air can thus flow out over the at least substantially entire seat surface 20, in order to achieve a particularly high level of comfort.

1.-10. (canceled)

11. A seat ventilation device for a seat system, comprising:
a plurality of radial fans for conveying air; and
a cushion which has a foam pad and a ventilation layer, wherein the ventilation layer is disposed above or in front of the foam pad and is permeatable by air conveyed by the plurality of radial fans;
wherein the plurality of radial fans are at least partially disposed in the foam pad and are disposed below or behind the ventilation layer.

12. The seat ventilation device according to claim 11, wherein the plurality of radial fans are completely disposed in the foam pad with respect to an axial extension of the plurality of radial fans.

13. The seat ventilation device according to claim 11, wherein in a direction of a seat surface or a backrest surface of the seat ventilation device the plurality of radial fans are each completely covered by the ventilation layer.

14. The seat ventilation device according to claim 11, wherein each of the plurality of radial fans has at least one outlet opening through which air is flowable and via which conveyed air is conductible out of the respective radial fan.

15. The seat ventilation device according to claim 14, wherein the respective at least one outlet opening or a respective inlet opening of the plurality of radial fans is completely covered by the ventilation layer in a direction of a seat surface of the seat ventilation device.

16. The seat ventilation device according to claim 14, wherein each of the plurality of radial fans has at least one fan wheel for conveying the air and at least one deflection channel through which the air is flowable and which has the respective at least one outlet opening for the conveyed air, wherein via the at least one deflection channel air which is conveyed by the at least one fan wheel is flowable into the at least one fan wheel in an axial direction and is flowable away from the at least one fan wheel in a radial direction and is deflectable such that air is flowable through the at least one outlet opening in the axial direction.

17. The seat ventilation device according to claim 11, wherein each of the plurality of radial fans has a first extension extending in an axial direction of the respective radial fan, wherein the ventilation layer has a second extension extending in the axial direction of the respective radial fan, and wherein the second extension is smaller than the first extension.

18. The seat ventilation device according to claim 11, wherein the plurality of radial fans include at least, or exactly, three radial fans.

19. The seat ventilation device according to claim 11, wherein two of the plurality of radial fans are disposed below ischial tuberosities of an occupant seated on the seat system and at least one other of the plurality of radial fans is disposed below a thigh of the occupant seated on the seat system.

20. The seat ventilation device according to claim 11, wherein the cushion is covered by a seat cover which has a plurality of passage openings for air conveyed by the plurality of radial fans.
